(19) United States
(12) Patent Application Publication
(10) Pub. No.: US 2023/0095151 A1
(43) Pub. Date: Mar. 30, 2023

(54) POLYURETHANE INSULATING FOAMS AND PRODUCTION THEREOF

(71) Applicant: EVONIK OPERATIONS GMBH, Essen (DE)

(72) Inventors: Michael SUCHAN, Recklinghausen (DE); Martin GLOS, Borken (DE)

(73) Assignee: EVONIK OPERATIONS GMBH, Essen (DE)

(21) Appl. No.: 17/800,297

(22) PCT Filed: Feb. 12, 2021
(86) PCT No.: PCT/EP2021/053433

§ 371 Date: Aug. 17, 2022

(30) Foreign Application Priority Data
Feb. 19, 2020 (DE) 10 2020 202 057.4

(51) Int. Cl. C08G 18/09; C08G 18/16; C08G 18/48; C08J 9/14; C08J 9/00; C08G 18/08

(52) U.S. Cl. CPC C08G 18/092; C08G 18/163; C08G 18/4829; C08J 9/141; C08J 9/0061; C08G 18/14; C08G 2110/0025; C08G 2101/00

(57) ABSTRACT

A process is described for producing PU foams, especially rigid PU foams, based on foamable reaction mixtures containing polyisocyanates, compounds having reactive hydrogen atoms, blowing agents, foam stabilizers, and possibly further additives, wherein polymer particles are additionally used, the average particle size of the polymer particles being <100 μm, preferably <70 μm, especially 5 to 50 μm.

The present invention is in the field of rigid polyurethane foams. More particularly, it relates to the production of rigid polyurethane foams using specific polymer particles, and additionally to the use of the foams which have been produced therewith.

The production of polyurethane foams by foaming foamable reaction mixtures based on isocyanates, compounds having reactive hydrogen atoms, blowing agents, stabilizers and possibly further additives nowadays is operated on a large industrial scale. To this end, all components except for the isocyanate are generally preformulated to give a processable mixture and this mixture is mixed with the isocyanate in a foaming installation. Foam formation and polyaddition reaction occur simultaneously in the initially liquid reaction mixture until the composition has cured to give the desired foam.

To produce thermoset insulating foams, it may for example be desirable to produce rigid foams having a preferably relatively low foam density of <60 kg/m³ and preferably a maximum number of small closed cells (high cell density). The cells should in this case preferably be distributed uniformly over the entire moulding, that is to say should not exhibit a gradient.

A blowing gas is necessary for such a foam to be able to form. This may for example be CO₂ which is formed from the reaction of isocyanate with water or is additionally added and/or an added low-boiling organic liquid.

For the sake of completeness it should be mentioned that in addition to foam formation during the polymerization reaction, as described here for the polyurethane formation, the foam formation can also take place in extrusion processes. However, these extrusion processes should be distinguished in principle from the polyurethane foam processes described here. WO 2002/034823 for instance describes an extrusion process for thermoplastics that leads to the formation of multimodal thermoplastic polymer foams. In contrast, the non-thermoplastic, instead thermoset, polyurethane foam systems that are preferably considered in the present case preferably feature a generally uniform, monomodal cell size distribution and also cannot be obtained by extrusion processes.

Rigid polyurethane and polyisocyanurate foams are usually produced using cell-stabilizing additives to ensure a fine-celled, uniform and low-defect foam structure and hence to exert an essentially positive influence on the performance characteristics, particularly the thermal insulation capacity, of the rigid foam. Surfactants based on polyether-modified siloxanes are particularly effective and therefore represent the preferred type of foam stabilizers.

EP1544235 describes typical polyether-modified siloxanes for rigid PU foam applications. Siloxanes having 60 to 130 silicon atoms and different polyether substituents R, the mixed molar mass of which is 450 to 1000 g/mol and the ethylene oxide content of which is 70 to 100 mol %, are used here.

Although these compounds affect the fineness and regularity of the cell structure to a certain extent, there is a limit to the fine-cell content beyond which cell refinement and an associated improvement in the thermal insulation action by means of further increasing the stabilizer concentration is not possible.

In order to make it possible to produce polyurethane foams having improved thermal insulation action, in the prior art heterogeneous nucleation on solids has been proposed as a technical solution, with zeolites in particular being used. For instance, WO2009092505A1 describes a process for producing polyurethane or polyisocyanurate insulating foams on the basis of foamable reaction mixtures containing polyisocyanates, compounds having reactive hydrogen atoms, blowing agents, stabilizers, nucleating agents and possibly further additives, the nucleating agents used being porous solids, in particular silicates having a zeolite structure.

However, there remains a need for enabling the provision of polyurethane foams having improved thermal insulation action. This corresponds to the object of the invention.

Surprisingly, it has now been found that a process for producing PU foams, especially rigid PU foams, based on foamable reaction mixtures containing polyisocyanates, compounds having reactive hydrogen atoms, blowing agents, foam stabilizers, and possibly further additives, wherein polymer particles are additionally used, the average particle size of the polymer particles being <100 μm, preferably <70 μm, especially 5 to 50 μm, achieves the stated object. This process forms part of the subject-matter of the invention.

A number of advantages accompany the invention. There is an improvement in the thermal insulation action of the resulting PU foams compared to corresponding foams without the admixture of the polymer particles. This effect is retained even when storage times which are customary in practice arise between the dispersion of the particles in the PU foam raw materials/systems and the processing of same to give the PU foam. The improved thermal insulation action of the resulting PU foams was observable both in the initial state and in the aged state of the foams. All other application-relevant foam properties are only insignificantly affected, if at all, by the polymer particles according to the invention. Even in the case of the quite sensitive surface quality of the foam test specimens, no changes, or at most only a marginal change, are found. A further very special advantage was recognized in the fact that the use of the polymer particles according to the invention is extraordinarily gentle on the moulds, in particular in direct comparison to zeolites, which in particular concerns the injection mould and the mixing head. There is no or barely any wear in the PU foaming installation.

Polyurethane (PU) in the context of the present invention is especially understood to mean a product obtainable by reaction of polyisocyanates and polyols or compounds having isocyanate-reactive groups. Further functional groups in addition to the polyurethane can also be formed in the reaction, examples being uretdiones, carbodiimides, isocyanurates, allophanates, biurets, ureas and/or uretonimines. Therefore, PU is understood in the context of the present invention to mean both polyurethane and polyisocyanurate, polyureas, and polyisocyanate reaction products containing uretdione, carbodiimide, allophanate, biuret and uretonimine groups. In the context of the present invention, polyurethane foam (PU foam) is especially understood to mean foam which is obtained as reaction product based on polyisocyanates and polyols or compounds having isocyanate-reactive groups. In addition to the eponymous polyurethane, further functional groups can be formed as well, examples being allophanates, biurets, ureas, carbodiimides, uretdiones, isocyanurates or uretonimines. Within the context of this invention, the term PU foams also encompasses what are called polyurethane foam mouldings, especially rigid polyurethane foam mouldings.

The polymer particles to be used according to the invention are distinguished by the fact that the average particle size of the polymer particles is <100 μm, preferably <70 μm, especially 5 to 50 μm. The average particle size (volume-average) of the polymer particles is determined according to ISO 13320-1 by means of laser diffraction spectroscopy.

The polymer particles to be used according to the invention and the processes for producing same are known per se. In particular, the polymerization of ethylenically unsaturated compounds is well known.

Corresponding polymer particles are also commercially available, such as for example corresponding polymethyl methacrylate particles, for example available from Evonik Industries AG as DEGACRYL®.

Particularly preferred molecular weights (Mw) for the polymethyl methacrylate are in the range from 200 000 to 1 500 000, preferably 300 000 to 1 000 000, in particular 350 000 to 700 000 Mw, determinable according to DIN 55672-1.

In a preferred embodiment of the invention, the polymer particles are formed from polymer comprising polyethylene (PE), polypropylene (PP), polyamide (in particular comprising PA6, PA6.6, PA10, PA11 and/or PA12), polyester (in particular comprising PET, PBT and/or PCL), polystyrene, polyacrylate, polymethyl methacrylate, polycarbonate, styrene-acrylonitrile copolymers, polyether, polylactic acid, polyurethane, polysulfones, polyethersulfone, polyetherimide, polyimide or mixtures thereof, in particular comprising polystyrene and/or polymethyl methacrylate.

In a preferred embodiment of the invention, the rigid polyurethane foam has a foam density of 5 to 900 kg/m³, preferably 8 to 800, particularly preferably 10 to 600 kg/m³, especially 20 to 150 kg/m³.

The efficacy of the polymer particles used according to the invention is advantageously independent of the polyurethane or polyisocyanurate basic formulation, that is to say the polymer particles can be employed for improving the thermal insulation properties in a great multitude of polyurethane or polyisocyanurate formulations. A reduction in the thermal conductivity through the admixture of the polymer particles can be observed both in formulations which have already been optimized with respect to low thermal conductivity exhaustively using methods known to those skilled in the art and correspond to the current state of the art for use as insulating foam and also in formulations which have been optimized with respect to other foam properties and do not yet display the optimum thermal conductivity achievable by the prior art.

The foams according to the invention have a thermal conductivity of preferably less than or equal to 25 mW/m*K, which can possibly be markedly reduced still further by means of the optional addition of further auxiliaries and additives known to those skilled in the art. A thermal conductivity of less than 20 mW/m*K is particularly preferred.

The values for thermal conductivity of the foams according to the invention both in the fresh and in the aged state of the foams are significantly below the thermal conductivity values of those foams that have been produced without the addition of polymer particles to be used according to the invention, but which have otherwise been produced in the same way; the thermal conductivity values are generally at least 0.5 to 1.5 mW/m″K lower. Evidence is provided for this in the examples.

The polymer particles to be used according to the invention may in addition be treated with a very wide variety of substances. Pretreatment of the polymer particles for controlled treatment of the particles can improve the cell-refining action of the particles even further when they are used to produce PU foams, especially rigid PU foams. For example, it has proved to be very advantageous within the context of the invention to treat the polymer particles with hydrocarbons having 3, 4 or 5 carbon atoms, preferably cyclo-, iso- and n-pentane, hydrofluorocarbons, preferably HFC 245fa, HFC 134a and HFC 365mfc, perfluorinated compounds such as perfluoropentane and perfluorohexane, hydrochlorofluorocarbons, preferably HCFC 141b, hydrofluoroolefins (HFO) or hydrohaloolefins such as for example 1234ze, 1234yf, 1224yd, 1233zd(E) or 1336mzz, oxygen-containing compounds such as methyl formate, acetone and dimethoxymethane, or chlorinated hydrocarbons, preferably dichloromethane and 1,2-dichloroethane. This corresponds to a preferred embodiment of the invention.

The invention therefore also provides for the use of correspondingly pretreated polymer particles, as described hereinabove, for the production of PU foams, especially rigid PU foams, and also provides the PU foams, especially rigid PU foams, produced in this way.

In a preferred embodiment of the invention, therefore, the polymer particles to be used according to the invention are pretreated for the treatment. In this case it is preferable for the polymer particles to be treated with the previously mentioned compounds, such as in particular with fluorine-containing organic compounds and/or linear, branched and/or cyclic hydrocarbons (in particular comprising propane, butane and/or pentane).

The polymer particles can be added directly to the reactive mixture for producing the PU foam or premixed in one of the components, preferably the polyol component, optionally with further auxiliaries and additives. This corresponds to a preferred embodiment of the invention.

The polymer particles are preferably used in amounts of 0.01 to 20 parts by weight, more preferably 0.05 to 5 parts by weight, especially 0.1 to 5 parts by weight, per 100 parts by weight of the polyol component. This corresponds to a particularly preferred embodiment of the invention.

The polymer particles used according to the invention are usable in the customary foamable formulations for PU foams, especially rigid PU foams formed from compounds having reactive hydrogen atoms (A), the polyisocyanate component (B) and customary auxiliaries and additives (C).

Polyols suitable as polyol components (A) for the purposes of the present invention are all organic substances having one or more isocyanate-reactive groups, preferably OH groups, and also formulations thereof.

Preferred polyols are all polyether polyols and/or polyester polyols and/or hydroxyl group-containing aliphatic polycarbonates, especially polyether polycarbonate polyols, and/or polyols of natural origin, known as “natural oil-based polyols” (NOPs), which are customarily used for producing polyurethane systems, such as preferably polyurethane coatings, polyurethane elastomers and especially foams. The polyols usually have a functionality of from 1.8 to 8 and preferably number-average molecular weights in the range from 500 to 15 000. The polyols having OH numbers in the range from 10 to 1200 mg KOH/g are typically used.

Isocyanates suitable as isocyanate components (B) for the purposes of this invention are all isocyanates containing at least two isocyanate groups. Generally, it is possible to use all aliphatic, cycloaliphatic, arylaliphatic and preferably aromatic polyfunctional isocyanates known per se.

Specific examples are: alkylene diisocyanates having 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomeric mixtures, and preferably aromatic diisocyanates and polyisocyanates such as toluene 2,4- and 2,6-diisocyanate (TDI) and the corresponding isomeric mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and toluene diisocyanates (TDI). The organic diisocyanates and polyisocyanates can be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

The terms “isocyanate component” and “polyisocyanates” are used synonymously in the context of the invention.

It is also possible to use isocyanates which have been modified by the incorporation of urethane, uretdione, isocyanurate, allophanate and other groups, called modified isocyanates.

Particularly suitable organic polyisocyanates which are therefore used with particular preference are various isomers of toluene diisocyanate (toluene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

A preferred ratio of isocyanate and polyol, expressed as the index of the formulation, that is to say as stoichiometric ratio of isocyanate groups to isocyanate-reactive groups (e.g. OH groups, NH groups) multiplied by 100, is in the range from 10 to 1000, preferably 80 to 500. An index of 100 represents a molar reactive group ratio of 1:1.

The auxiliaries and additives (C) used may in particular be the compounds that are customary for the formulation of PU foams, especially rigid PU foams, including catalysts, foam stabilizers, blowing agents, flame retardants, fillers, colourants and light stabilizers.

Suitable catalysts for the purposes of the present invention are substances catalysing the gel reaction (isocyanate-polyol), the blowing reaction (isocyanate-water) or the di- or trimerization of the isocyanate. It is possible here to make use of the customary catalysts known from the prior art, including, for example, amines (cyclic, acyclic; monoamines, diamines, oligomers having one or more amino groups), ammonium compounds, organometallic compounds and metal salts, preferably those of tin, iron, bismuth, potassium and zinc. In particular, it is possible to use mixtures of a plurality of components as catalysts. Suitable amounts used depend on the type of catalyst and are in particular in the range from 0.05 to 5 parts by weight, or 0.1 to 10 parts by weight for potassium salts, based on 100 parts by weight of polyol.

Suitable foam stabilizers are surface-active substances such as for example organic surfactants or preferably polyether-modified siloxanes (PES). In the context of this invention, it is possible here to use any of those that promote foam production (stabilization, cell regulation, cell opening, etc.).

These compounds are sufficiently well known from the prior art. Typical amounts of polyether siloxane foam stabilizers used are preferably from 0.5 to 5 parts by weight per 100 parts by weight of polyol, preferably from 1 to 3 parts by weight per 100 parts by weight of polyol.

Corresponding PES usable in the context of this invention are described, for example, in the following patent specifications: CN 103665385, CN 103657518, CN 103055759, CN 103044687, US 2008/0125503, US 2015/0057384, EP 1520870 A1, EP 1211279, EP 0867464, EP 0867465, EP

Water is preferably added as chemical blowing agent to the foamable formulation, since it reacts with isocyanates with the evolution of carbon dioxide gas. Suitable water contents for the purposes of this invention depend on whether or not physical blowing agents are used in addition to the water. In the case of purely water-blown foams, the values are preferably in the range from 1 to 20 parts by weight per 100 parts by weight of polyol, but, when other blowing agents are used in addition, the amount used is preferably reduced to 0.1 to 5 parts by weight per 100 parts by weight of polyol.

Physical blowing agents used may be appropriate compounds having suitable boiling points. It is likewise possible to use chemical blowing agents which react with NCO groups to liberate gases, for example the already mentioned water or formic acid. Examples of blowing agents are liquefied CO2, nitrogen, air, volatile liquids, for example hydrocarbons having 3, 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, hydrofluoroolefins (HFO) or hydrohaloolefins such as for example 1234ze, 1234yf, 1224yd, 1233zd(E) or 1336mzz, oxygen-containing compounds such as methyl formate, acetone and dimethoxymethane, or chlorinated hydrocarbons, preferably dichloromethane and 1,2-dichloroethane.

As additives, it is possible to use all substances which are known from the prior art and are used in the production of polyurethanes, especially polyurethane foams, for example crosslinkers and chain extenders, stabilizers against oxidative degradation (known as antioxidants), flame retardants, surfactants, biocides, cell openers, solid fillers, antistatic additives, thickeners, dyes, pigments, colour pastes, fragrances, emulsifiers etc.

Insulation foams for the thermal insulation of buildings are subject to fire safety requirements. Flame retardants usable for this purpose are preferably liquid organophosphorus compounds such as halogen-free organophosphates, e.g. triethyl phosphate (TEP), halogenated phosphates, for example tris(1-chloro-2-propyl) phosphate (TCPP) and tris(2-chloroethyl) phosphate (TCEP), and organic phosphonates, for example dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine.

The present invention further provides:
(I) a composition suitable for the production of rigid polyurethane or polyisocyanurate foams and containing at least one isocyanate component, at least one polyol component, at least one foam stabilizer, at least one urethane and/or isocyanurate catalyst, water and/or blowing agent, and optionally at least one flame retardant and/or further additives, which is characterized in that polymer particles are additionally used, the average particle size of the polymer particles being <100 μm, preferably <70 μm, especially 5 to 50 μm,
(II) a process for producing rigid polyurethane or polyisocyanurate foams by reacting this composition and also
(III) the rigid polyurethane or polyisocyanurate foams obtainable thereby. In order to avoid repetitions, with respect to the aforementioned subject-matter, in particular the composition according to the invention, reference should also expressly be made to the previous statements concerning the process according to the invention, which are correspondingly valid for the aforementioned subject-matter. This applies in particular to the previously mentioned preferred embodiments.

The present invention additionally provides for the use of polyurethane foams according to the invention as insulating panels and insulant, and also a cooling apparatus which includes a polyurethane foam according to the invention as insulating material.

The invention yet further provides for the use of the polymer particles as characterized hereinabove in the description for the reduction of the thickness of a rigid PU foam insulation layer while maintaining the thermal insulation performance, especially in insulating panels and insulants. The invention still further provides a dispersion for use in compositions according to the invention for polyurethane foam, comprising polymer particles as characterized hereinabove in the description and at least one polyol and/or solvent, optionally blowing agent and/or optionally dispersing additives. Polyol and optional blowing agent are characterized in particular according to the stipulations as set forth hereinabove in the description. Suitable solvents include mono-, di- and polyfunctional alcohols such as for example monoethylene glycol (MEG), diethylene glycol (DEG), dipropylene glycol (DPG), alkoxylates or organic solvents such as for example DMSO or propylene carbonate. The polymer particles may also be preladen or treated with the abovementioned compounds in the dispersion, in particular with hydrocarbons having 3, 4 or 5 carbon atoms, preferably cyclo-, iso- and n-pentane, hydrofluorocarbons, preferably HFC 245fa, HFC 134a and HFC 365mfc, perfluorinated compounds such as perfluoropentane and perfluorohexane, hydrochlorofluorocarbons, preferably HCFC 141b, hydrofluoroolefins (HFO) or hydrohaloolefins such as for example 1234ze, 1234yf, 1224yd, 1233zd(E) or 1336mzz, oxygen-containing compounds such as methyl formate, acetone and dimethoxymethane, or chlorinated hydrocarbons, preferably dichloromethane and 1,2-dichloroethane.

Suitable dispersing additives are known to those skilled in the art. Additives are known which improve the dispersing, that is to say the optimal mixing of at least two intrinsically immiscible phases or substances. Preferably usable dispersing additives are described for example in DE 199 40 797 A1 and DE 100 29 648 01.

A dispersion, comprising polymer particles as characterized hereinabove in the description and at least one foam stabilizer (in particular polyether siloxane), optionally polyol and/or solvent and/or optionally dispersing additives, corresponds to a preferred embodiment of the invention.

A preferred PU foam formulation in the context of this invention comprises the polymer particles according to the invention and results in a foam density of 10 to 900 kg/m³ and has the following composition, according to a preferred embodiment of the invention:

| Component | Proportion by weight |
|---|---|
| Polyol | 0.1 to 100 |
| Amine catalyst | 0 to 5 |
| Metal catalyst | 0 to 10 |
| Polyether siloxane | 0.1 to 5 |
| Water | 0.01 to 20 |
| Blowing agent | 0 to 40 |
| Polymer particles according to the invention | >0 to 5 |
| Further additives (flame retardants, etc.) | 0 to 90 |
| Isocyanate index: 10 to 1000 | |

The formulations according to the invention can be processed to give the desired PU foams by any methods familiar to those skilled in the art.

Rigid polyurethane foam or rigid PU foam is an established technical term. The known and fundamental difference between flexible foam and rigid foam is that flexible foam shows elastic characteristics and hence deformation is reversible. By contrast, rigid foam is permanently deformed. In the context of the present invention, rigid polyurethane foam is especially understood to mean a foam to DIN 7726 that has a compressive strength to DIN 53 421/DIN EN ISO 604:2003-12 of advantageously ≥20 kPa, by preference ≥80 kPa, preferably ≥100 kPa, more preferably ≥150 kPa, particularly preferably ≥180 kPa. In addition, the rigid polyurethane foam, according to DIN EN ISO 4590:2016-12, advantageously has a closed-cell content of greater than 50%, preferably greater than 80% and particularly preferably greater than 90%.

The rigid PU foams according to the invention can be used as or for production of insulation materials, preferably insulating panels, refrigerators, insulating foams, roof liners, packaging foams or spray foams.

The PU foams according to the invention can be used advantageously particularly in the refrigerated warehouse, refrigeration appliances and domestic appliances industry, for example for production of insulating panels for roofs and walls, as insulating material in containers and warehouses for frozen goods, and for refrigeration and freezing appliances.

Further preferred fields of use are in vehicle construction, especially for production of vehicle inner roof liners, bodywork parts, interior trim, cooled vehicles, large containers, transport pallets, packaging laminates, in the furniture industry, for example for furniture parts, doors, linings, in electronics applications.

The invention further provides for the use of the rigid PU foam as insulation material in refrigeration technology, in refrigeration equipment, in the construction sector, automobile sector, shipbuilding sector and/or electronics sector, as insulating panels, as spray foam, as one-component foam.

The examples which follow describe the present invention by way of example, without any intention of restricting the invention, the scope of application of which is apparent from the entirety of the description and the claims, to the embodiments cited in the examples.

### EXAMPLES

### Example 1: Rigid PUR Foam

The following foam formulation was used for the performance comparison:

| Component | Proportion by weight |
|---|---|
| Polyether polyol* | 100 |
| Catalyst** | 2 |
| Polyether siloxane*** | 2 |
| Water | 1 |
| Cyclopentane | 14 |
| Polymer particles according to the invention**** | 1 |
| MDI***** | 154 |

*Daltolac ® R 471 from Huntsman, OH number 470 mg KOH/g
**POLYCAT ® 8 from Evonik Industries AG
***TEGOSTAB ® B 84510 from Evonik Industries AG
****DEGACRYL ® M 527, polymethyl methacrylate powder, average particle size 33-41 μm according to ISO 13320-1, from Evonik Industries AG
*****Polymeric MDI, 200 mPa*s, 31.5% NCO, functionality 2.7.

The comparative foamings were carried out by hand mixing. For this purpose, polyol, catalysts, water, foam stabilizer, particles and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, the reaction mixture was stirred with the stirrer described at 2500 rpm for 7 s and immediately transferred into an aluminium mould thermostatted to 45° C. and having a size of 145 cm×14 cm×3.5 cm, the mould being inclined at an angle of 10° (along the 145 cm long side) and lined with polyethylene film. The foam formulation was in this case introduced at the lower side, so that the expanding foam fills the mould in the feed region and rises in the direction of the higher side. The amount of foam formulation used was calculated such that it was 10% above the amount necessary for minimum filling of the mould.

After 10 min, the foams were demoulded. One day after foaming, the foams were analysed. Surface and internal defects were assessed subjectively on a scale from 1 to 10, where 10 represents an (idealized) impeccable foam and 1 represents a very significantly defective foam. The thermal conductivity coefficient was measured on 2.5 cm thick discs using a Hesto A Control instrument at temperatures of 10° C. and 36° C. for the bottom side and the top side of the sample. For the determination of an ageing value for the thermal conductivity, the test specimens were stored at 70° C. over 7 days and then measured again. The open-cell content was measured using an AccuPyc II 1340 gas pycnometer from Micromeritics.

The results are compiled in the table which follows:

| | Reference | According to |
|---|---|---|
| Parameter | (without particles) | the invention |
| Density kg/m³ | 50.2 | 50.2 |
| Thermal conductivity | 22.8 | 21.7 |
| mW/m*K initial | | |
| Thermal conductivity | 24.4 | 23.4 |
| mW/m*K aged | | |
| Open-cell content % | 6.6 | 6.1 |
| Defects | 5/5.5/4 | 5/5/4.5 |
| (top/bottom/internal) | | |

The results show that a significant improvement in the thermal conductivity can be achieved with the particles according to the invention. The values, both in the fresh and in the aged state, are very significantly below the reference value of the foam without addition of polymer particles. All other application-relevant foam properties are only insignificantly affected, if at all, by the particles according to the invention. Even in the case of the quite sensitive surface quality of the foam test specimens, no deterioration, or only a marginal deterioration, is found.

### Example 2: Rigid PIR Foam

The following foam formulation was used for the performance comparison:

| Component | Proportion by weight |
|---|---|
| Polyester polyol* | 100 |
| Amine catalyst** | 0.6 |
| Potassium trimerization catalyst*** | 4 |
| Polyether siloxane**** | 2 |
| Water | 1 |
| Cyclopentane | 16 |
| Flame retardant TCPP | 15 |
| Polymer particles according to the invention***** | 1 |
| MDI****** | 199 |

*Stepanpol ® PS 2352 from Stepan, OH number 250 mg KOH/g
**POLYCAT ® 5 from Evonik Industries AG
***KOSMOS ® 75 from Evonik Industries AG
****TEGOSTAB ® B 84510 from Evonik Industries AG
*****DEGACRYL ® M 527, polymethyl methacrylate powder, average particle size 33-41 μm according to ISO 13320-1, from Evonik Industries AG
******Polymeric MDI, 200 mPa*s, 31.5% NCO, functionality 2.7.

The comparative foamings were carried out by hand mixing. For this purpose, polyol, catalysts, water, foam stabilizer, flame retardant, particles and blowing agent were weighed into a beaker and mixed by means of a disc stirrer (diameter 6 cm) at 1000 rpm for 30 s. By reweighing, the amount of blowing agent that had evaporated in the mixing operation was determined and added again. The MDI was now added, the reaction mixture was stirred with the stirrer described at 3000 rpm for 5 s and immediately transferred into an aluminium mould thermostatted to 60° C. and having a size of 25 cm×50 cm×7 cm, the mould being lined with polyethylene film.

After 10 min, the foams were demoulded. One day after foaming, the foams were analysed. Surface and internal defects were assessed subjectively on a scale from 1 to 10, where 10 represents an (idealized) impeccable foam and 1 represents a very significantly defective foam. The thermal conductivity coefficient was measured on 2.5 cm thick discs using a Hesto A Control instrument at temperatures of 10° C. and 36° C. for the bottom side and the top side of the sample. For the determination of an ageing value for the thermal conductivity, the test specimens were stored at 70° C. over 7 days and then measured again. The open-cell content was measured using an AccuPyc II 1340 gas pycnometer from Micromeritics.

The results are compiled in the table which follows:

| | Reference | According to |
|---|---|---|
| Parameter | (without particles) | the invention |
| Density kg/m³ | 37.1 | 37.2 |
| Thermal conductivity | 21.0 | 20.2 |
| mW/m*K initial | | |
| Thermal conductivity | 24.5 | 23.3 |
| mW/m*K aged | | |
| Open-cell content % | 12.2 | 13.1 |

The results again show that a significant improvement in the thermal conductivity can be achieved with the polymer particles according to the invention, with the values both in the fresh and in the aged state here too being significantly below the reference value of the foam without addition of polymer particles.

It should be particularly emphasized here that even a very small addition of particles according to the invention leads to measurable improvements.

All other application-relevant foam properties are only insignificantly affected, if at all, by the particles according to the invention. Even in the case of the quite sensitive surface quality of the foam test specimens, no deterioration, or only a marginal deterioration, is found.

1-12. (canceled)

13. A composition for the production of rigid polyurethane foam, comprising at least one isocyanate component, a polyol component, and optionally, one or more components selected from the group consisting of: a catalyst which catalyses the formation of a urethane or isocyanurate bond; a blowing agent; and a foam stabilizer; and wherein the composition additionally comprises polymer particles with an average particle size of <100 μm.

14. The composition of claim 13, wherein the polymer particles have an average particle size of <70 μm.

15. The composition of claim 13, wherein the polymer particles have an average particle size of 5 to 50 μm.

16. The composition of claim 13, wherein the polymer particles are formed from a polymer selected from the group consisting of: polyethylene, polypropylene, polyamide, polyester, polystyrene, polyacrylate, polymethyl methacrylate, polycarbonate, styrene-acrylonitrile copolymers, polyether, polylactic acid, polyurethane, polysulfone, polyethersulfone, polyetherimide, polyimide and mixtures thereof.

17. The composition of claim 13, wherein the polymer particles are formed from a polymer selected from the group consisting of: a polyamide selected from the group consisting of: PA6, PA6.6, PA10, PA11 and PA12; a polyester selected from the group consisting of: polyethylene terephthalate, polybutylene terephthalat and poly-ε-caprolactone; and mixtures thereof.

18. The composition of claim 13, wherein the polymer particles are formed from polystyrene and/or polymethyl methacrylate.

19. The composition of claim 13, wherein the polymer particles are used in a total amount of 0.01 to 20 parts per 100 parts of polyol.

20. The composition of claim 13, wherein the polymer particles are used in a total amount of 0.1 to 5 parts per 100 parts of polyol.

21. The composition of claim 13, wherein the polymer particles are treated with a hydrocarbon having 3, 4 or 5 carbon atoms; a perfluorinated compound; a hydrochloro-fluorocarbon; a hydrohaloolefin; an oxygen-containing compound; or a chlorinated hydrocarbon.

22. The composition of claim 13, wherein the polymer particles are treated with a cyclo-, iso- or n-pentane hydrofluorocarbon; a perfluorinated compound selected from the group consisting of: perfluoropentane, perfluorohexane, and mixtures thereof; a hydrochloro-fluorocarbon selected form the group consisting of: HCFC 141b, hydrofluoroolefins (HFO) and mixtures thereof; a hydrohaloolefin selected from the group consisting of: 1234ze, 1234yf, 1224yd, 1233zd(E) and 1336mzz; an oxygen-containing compound selected from the group consisting of: ethyl formate, acetone and dimethoxymethane; or a chlorinated hydrocarbon selected from the group consisting of: dichloromethane and 1,2-dichloroethane.

23. The composition of claim 16, wherein the polymer particles have an average particle size of 5 to 50 μm.

24. The composition of claim 23, wherein the polymer particles are used in a total amount of 0.01 to 20 parts per 100 parts of polyol.

25. The composition of claim 24, wherein the polymer particles are treated with a hydrocarbon having 3, 4 or 5 carbon atoms; a perfluorinated compound; a hydrochloro-fluorocarbon; a hydrohaloolefin; an oxygen-containing compound; or a chlorinated hydrocarbon.

26. The composition of claim 25, wherein the polymer particles are formed from polystyrene and/or polymethyl methacrylate.

27. The composition of claim 26, wherein the polymer particles are used in a total amount of 0.1 to 5 parts per 100 parts of polyols.

28. A process for producing polyurethane foams, comprising reacting a foamable reaction mixture containing polyisocyanates, compounds having reactive hydrogen atoms, blowing agents, foam stabilizers, and, optionally, further additives, and wherein the reaction mixture additionally comprises polymer particles with an average particle size of <100 μm.

29. The process of claim 28, wherein the polymer particles have an average particle size of 5 to 50 μm.

30. The process of claim 29, wherein the polymer particles are formed from a polymer selected from the group consisting of: polyethylene, polypropylene, polyamide, polyester, polystyrene, polyacrylate, polymethyl methacrylate, polycarbonate, styrene-acrylonitrile copolymers, polyether, polylactic acid, polyurethane, polysulfone, polyethersulfone, polyetherimide, polyimide and mixtures thereof.

31. The process of claim 30, wherein the polymer particles are present in a total amount of 0.01 to 20 parts per 100 parts of polyols.

32. A dispersion comprising polymer particles having an average particle size of 5 to 50 μm, wherein the dispersion further comprises at least one polyol and/or solvent, optionally a blowing agent and/or dispersing additive, and wherein the polymer particles are treated with a fluorine-containing organic compound and/or a linear, branched or cyclic hydrocarbon.
